(19) United States
(12) Patent Application Publication
(10) Pub. No.: US 2026/0336855 A1
(43) Pub. Date: Oct. 29, 2026

(54) A METHOD OF PRODUCING PLASTIC CONTAINERS

(71) Applicant: CREATIVE PROPACK LTD., Mumbai, Maharashtra (IN)

(72) Inventor: Vinod Agarwal, Mumbai City (IN)

(21) Appl. No.: 19/491,146

(22) PCT Filed: Sep. 28, 2023
(86) PCT No.: PCT/IN2023/050894

§ 371 Date: Dec. 8, 2025

(30) Foreign Application Priority Data
Jun. 27, 2023 (IN) 202321043138

(51) Int. Cl. B65D 1/02; B29C 49/04; B29K 23/00; B29L 31/00; B65D 1/42

(52) U.S. Cl. CPC B65D 1/0223; B29C 49/04116; B65D 1/42; B29C 2949/0741; B29C 2949/0746; B29C 2949/081; B29K 2023/0608; B29K 2023/12; B29L 2031/7158; B65D 2501/0027; B65D 2501/0036

(57) ABSTRACT

A method of producing containers is disclosed herein, wherein the container has reinforcing ribs on its inner wall. The method comprises extruding one or more layers of molten thermoplastic around a mandrel; forming a parison with combination of circumferential & longitudinal grooves; and blowing compressed air into the formed parison to form the container with combination of circumferential & longitudinal reinforcing ribs on an inner wall of the container. The container produced from the said method has a greater compressional strength and is applicable for variety of purposes.

### FIELD OF INVENTION

The present invention relates to making containers, and more particularly, to producing the plastic containers with patterns on inner surface.

### BACKGROUND OF THE INVENTION

Plastic containers are widely used for number of commercial purposes. The containers may be in the form of cylindrical bottles for storage of liquid and solids. In most of the uses, the strength of the container is critical. Smart selection of material of construction takes care of the strength factor. However, to provide further strength to the container, reinforcing ribs are structurally included around the body of the container. Most typically, such reinforcing ribs are included at the outer surface of the body of the container. However, with this, the outer surface becomes uneven, and not so adaptable for labeling and decoration purpose.

To overcome said issue, some selected producers started the practice of incorporating the reinforcing ribs at an inner surface of the container. The current applicant is one such producer and has been granted patent IN403144. In the said patent, wherein the container & a method of forming the same is disclosed, the current applicant has demonstrated that the inclusion of reinforcing ribs on the inner surface has increased the compression strength of the container for the constant volume and weight.

The applicant herein proposes a method by which plastic containers having further greater compression and hoop strength may be produced effectively.

### SUMMARY OF INVENTION

It a primary object of the invention to provide greater compression and hoop strength to the plastic container.

It is an object of the invention to provide a method by which the plastic container having patterns on its inner wall may be produced.

The method of producing the container comprises steps of: extruding one or more layers of molten thermoplastic around a mandrel; subjecting the layers for programming; forming a parison with combination of circumferential & longitudinal grooves; and blowing compressed air into the formed parison to form the container with combination of circumferential & longitudinal reinforcing ribs on the inner wall.

The longitudinal reinforcing ribs on the inner wall of the container correspond to plurality of longitudinal indentations provided on a mandrel, whereas the circumferential reinforcing ribs correspond to circumferential grooves provided during processing (e.g. parison programing). For example, during parison programming, the gap between die and mandrel may be changed to change the thickness of the parison.

In an embodiment, the longitudinal indentations on the mandrel are present in range of 4 to 64. The adjacent longitudinal indentations are spaced apart in range of 0.5 mm to 10 mm. Each of the longitudinal indentations has depth of 0.1 mm to 10 mm, and width of 0.1 mm to 10 mm.

In the same embodiment, the circumferential grooves are present in range of 1 to 15, wherein adjacent circumferential grooves are spaced apart in range of 1 mm to 500 mm. Each of the circumferential groove has depth of 0.1 mm to 10 mm, and width of 0.1 mm to 10 mm.

The thermoplastic material is selected from High Density Poly Ethylene (HDPE), Low Density Poly Ethylene (LDPE), Linear Low Density Poly Ethylene (LLDPE), Polypropylene (PP), their blends, PCR (Post-Consumer Recycled Material or Post Consumer Resin) and such.

The present invention also discloses a container which is produced by the method and the apparatus disclosed above.

The said container comprises a neck, and a body made of thermoplastic material. The container has an inner surface provided with a combination of circumferential & longitudinal reinforcing ribs.

The longitudinal reinforcing ribs are present in range of 4 to 64. The adjacent longitudinal ribs are spaced apart in range 2 to 50 mm. Each of the longitudinal indentations has depth of 0.05 mm to 8 mm, and width of 0.3 mm to 30 mm The circumferential ribs are present in range of 1 to 15, wherein adjacent ribs are spaced apart in range of 5 to 300 mm. Each of the circumferential ribs has depth of 0.05 mm to 8 mm, and has width of 0.3 mm to 30 mm.

The container described above show increased compression strength in range of 10% to 50%.

### BRIEF DESCRIPTION OF DRAWINGS:

Following figures illustrate various aspects of the present invention.

FIG. 1(a) shows a divergent mandrel with longitudinal indentations.

FIG. 1(b) shows a convergent mandrel with longitudinal indentations.

FIG. 2 shows a parison forming with circumferential grooves.

FIG. 3 represents an example of the finished container, in the form of bottle.

### DETAILED DESCRIPTION OF THE INVENTION:

Accordingly, the present invention discloses a method and an apparatus for producing containers. While describing the invention, certain terms and expressions are recognised and understood by the persons skilled in the art. The present description does not intend to deviate from those meanings.

The present description describes various aspects of the present invention, including a preferred embodiment and its alterations. Some of the aspects are supported by the figures. However, the description as well as the figures do not intend to restrict the scope of the invention. Any variation in the description as well as figures introduced by any person, including a person skilled in the art, will be falling in the extent of the present invention.

Accordingly, a method of producing containers is described herein, which comprises: extruding one or more layers of molten thermoplastic around a mandrel; subjecting the layer for programming; forming a parison with combination of circumferential & longitudinal grooves on inner side; and blowing compressed air into the formed parison to form the container with combination of circumferential & longitudinal reinforcing ribs on inner wall.

The said thermoplastic to be extruded may be selected from High Density Poly Ethylene (HDPE), Low Density Poly Ethylene (LDPE), Linear Low Density Poly Ethylene (LLDPE), Polypropylene (PP), their blends, PCR (Post Consumer Recycles) and such.

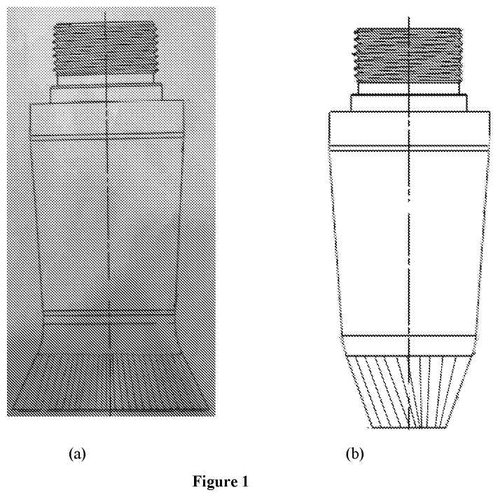

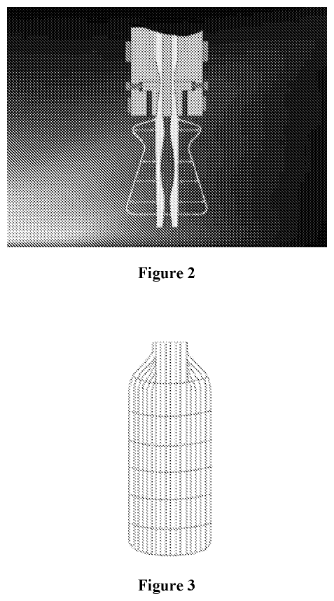

The parison is formed between die and the mandrel unit, wherein the parison has a combination of longitudinal and circumferential grooves on it. The said longitudinal grooves on the parison are a consequence of the indentations provided on the mandrel as shown in FIG. 1, whereas said circumferential grooves are provided during processing step as shown in FIG. 2. After the molten thermoplastics are transferred through the mandrel, the longitudinal and circumferential grooves are formed onto the inner side of the parisons.

It may be noted that FIG. 1(a) represents a divergent madrel, whereas FIG. 1(b) represents a convergent mandrel. The mandrels in the said figures may be used as per the requirement.

The formed parisons are captured between molds and are either blown in reciprocating blow molding machine or transferred to blowing station in continuous blow molding machine, wherein the compressed air is blown into the formed parisons, inflating the parisons into the containers and cooled to form the containers as a final product with circumferential and longitudinal ribs on the inner surface of the containers.

In an embodiment, the longitudinal indentations on the mandrel are present in range of 4 to 64. In a more preferred embodiment, the longitudinal indentations are in the range of 20 to 40.

In an embodiment, the adjacent longitudinal indentations are spaced apart in range of 0.5 mm to 10 mm. In a preferred embodiment, the adjacent longitudinal indentations are spaced apart at a distance ranging from 0.7 mm to 1.5 mm.

Each of the longitudinal indentations has depth of 0.1 mm to 10 mm, and width of 0.1 mm to 10 mm. In a preferred embodiment, the longitudinal indentations have depth in the range of 0.2 mm to 1 mm and width of 0.4 mm to 1.5 mm.

In an embodiment, the circumferential grooves are present in range of 1 to 15. In a preferred embodiment, the circumferential indentations are present in range of 2 to 6.

In an embodiment, the adjacent circumferential grooves are spaced apart in range of 1 mm to 500 mm. In a preferred embodiment, the adjacent circumferential grooves are spaced apart in range of 20 mm to 300 mm.

In an embodiment, the circumferential grooves have depth of 0.1 mm to 10 mm and width of 0.1 mm to 10 mm. In a preferred embodiment, each of the circumferential groove has depth of 0.2 mm to 1 mm and width of 0.4 mm to 1.5 mm.

The container so formed has reinforcing longitudinal & circumferential ribs on its inner wall, as shown in FIG. 3, which correspond to the longitudinal indentations inscribed on the mandrel and circumferential grooves provided by parison programming.

In a preferred embodiment, the longitudinal ribs are present in range of 4 to 64. The longitudinal ribs are spaced apart in range of 2 mm to 50 mm. The longitudinal ribs have depth of 0.05 mm to 8 mm and width of 0.3 mm to 30 mm. The circumferential ribs are present in range of 1 to 15. The circumferential ribs are spaced apart in range of 5 mm to 300 mm The circumferential ribs have depth of 0.05 to 8 mm and width of 0.3 mm to 30 mm.

The container so formed has greater compression strength. In an exemplary embodiment, the compression strength of the so formed container is increased by 10% to 50%. This allows light weighting of the container by 5% to 25% with equivalent compression strength.

It may be noted that, in the context of the present invention, the container may be any container adapted to store liquid or semi-liquid or solid like powders, pills, etc. Therefore, the container could be a bottle in which a mineral water, or a beverage or personal care products or homecare products may be stored. Further, in the context of the present invention, the container may be any container adapted to store pharmaceutical or medicinal liquid. As such, there is no restriction in which field the present container is used. The container may be used to store any suitable liquid or solid, where compression strength of the container matters.

We claim:

1. A method of producing containers comprises
extruding one or more layers of molten thermoplastic around a mandrel;
forming a parison with combination of circumferential & longitudinal grooves, wherein said longitudinal grooves correspond to plurality of indentations inscribed on a mandrel and said circumferential grooves correspond to plurality of circumferential indentations formed during parison programming; and
blowing compressed air into the formed parison to form the container with combination of circumferential & longitudinal reinforcing ribs on an inner wall of the container.
wherein the longitudinal indentations are present in range of 4 to 64; the adjacent longitudinal indentations are spaced apart at a distance ranging from 0.5 mm to 10 mm; the longitudinal indentations have depth of 0.1 mm to 10 mm; the longitudinal indentations have width of 0.1 mm to 10 mm; the circumferential grooves are present in range of 1 to 15; the circumferential grooves are spaced apart in range of 1 mm to 500 mm; the circumferential grooves have depth of 0.1 mm to mm; the circumferential grooves have width of 0.1 mm to 10 mm.

2. (canceled)

3. The method as claimed in claim 1, wherein the longitudinal indentations are in the range of 20 to 40.

4. (canceled)

5. The method as claimed in claim 41, wherein the adjacent longitudinal indentations are spaced apart at a distance ranging from 0.7 mm to 1.5 mm.

6. (canceled)

7. The method as claimed in claim 1, wherein the longitudinal indentations have depth in the range of 0.2 mm to 1 mm.

8. (canceled)

9. The method as claimed in claim 1, wherein the longitudinal indentations have width of 0.4 mm to 1.5 mm.

10. (canceled)

11. The method as claimed in claim 1, wherein the circumferential grooves are present in range of 2 to 6.

12. (canceled)

13. The method as claimed in claim 1, wherein the circumferential grooves are spaced apart in the range of 20 mm to 300 mm.

14. (canceled)

15. The method as claimed in claim 1, wherein the circumferential grooves have depth of between 0.2 mm to 1 mm.

16. (canceled)

17. The method as claimed in claim 1, wherein the circumferential grooves have width of 0.4 mm to 1.5 mm.

18. The method as claimed in claim 1, wherein the thermoplastic material is selected from High Density Poly Ethylene (HDPE), Low Density Poly Ethylene (LDPE), Linear Low Density Poly Ethylene (LLDPE), Polypropylene (PP), their blends, PCR and such.

19. The method as claimed in claim 1, wherein compression strength of the container is increased in range of 10% to 50%.

20. A container comprising a neck, and a body made of thermoplastic material; wherein an inner surface of the body is provided with a combination of circumferential & longitudinal reinforcing ribs, wherein the longitudinal ribs are present in range of 4 to 64; the longitudinal ribs are spaced apart in range of 2 mm to 50 mm; the longitudinal ribs have depth of 0.05 mm to 8 mm; the longitudinal ribs have width of 0.3 mm to 30 mm; the circumferential ribs are present in range of 1 to 15; the circumferential ribs are spaced apart in range of 5 mm to 300 mm; the circumferential ribs have depth of 0.05 mm to 8 mm; the circumferential ribs have width of 0.3 mm to 30 mm.

21-28: (canceled)

29. The container as claimed in claim 20, wherein compression strength of the container is increased by 10% to 50%.

30. The container as claimed in claim 20, wherein the thermoplastic material is selected from High Density Poly Ethylene (HDPE), Low Density Poly Ethylene (LDPE), Linear Low Density Poly Ethylene (LLDPE), Polypropylene (PP), their blends, PCR and such.
